(19) United States
(12) Patent Application Publication
(10) Pub. No.: US 2004/0220746 A1
(43) Pub. Date: Nov. 4, 2004

(54) Methods and systems for preparing virtual representations of molecules

(75) Inventor: Frank P. Hollinger, Wayne, PA (US)

Correspondence Address: STERNE, KESSLER, GOLDSTEIN & FOX PLLC, 1100 NEW YORK AVENUE, N.W., WASHINGTON, DC, 20005, US

(73) Assignee: Locus Pharmaceuticals, Inc., Blue Bell, PA

(21) Appl. No.: 10/791,681

(22) Filed: Mar. 3, 2004

Related U.S. Application Data
(60) Provisional application No. 60/450,711, filed on Mar. 3, 2003.

(51) Int. Cl. G06F 7/00; G06F 17/30; G06G 7/48; G06G 7/58; G06F 19/00

(52) U.S. Cl. 702/19; 703/11

(57) ABSTRACT

Methods and systems for improving virtual representations of large molecules provide a “prepared” virtual representation of the target protein. The prepared virtual representation of the target protein is useful for further in-silico, or computer processing. Further processing can include, without limitation, designing of small molecules that will potentially bind and/or interact with the target protein. In accordance with the invention, one or more features of the virtual representation of the protein are assessed. One or more of a variety of assessments can be performed including, without limitation, analyzing for completeness (e.g., missing and/or incomplete residues and/or side chains), identifying missing (typically smaller) atoms, determining ionization states (i.e., protonated or not), determining orientation of bonds, and/or identifying atoms that are not part of the protein. The virtual representation of the protein is then modified, as needed, based, at least in part, on the assessment(s). Modification can include, without limitation, refining, improving, tailoring, editing, and/or revising the virtual representation of the protein.

### CROSS-REFERENCE TO RELATED APPLICATIONS

This application claims the benefit of priority to U.S. Provisional Application No. 60/450,711 filed on Mar. 3, 2003 and incorporated by reference herein in its entirety.

### BACKGROUND OF THE INVENTION

1. Field of the Invention

The present invention is related to computational chemistry and, more particularly, to virtual molecule preparation and, more particularly still, to virtual protein crystal structure preparation.

2. Related Art

Molecules can be represented virtually for in-silico, or computer processing. Virtual representations of molecules can be in the form of three dimensional (“3D”) coordinates assigned to atoms of the molecules.

Of particular interest here are relatively large molecules, such as proteins. Conventional virtual representations of relatively large molecules, such as proteins, are generated from data obtained through x-ray crystallography, nuclear magnetic resonance imaging (“NMR”), or homology searching. Virtual representations of approximately 30,000 proteins are publicly available from a Protein Data Bank (“PDB”), accessible at http://www.rcsb.org/pdb/, which is incorporated herein by reference in its entirety.

Conventional molecule imaging technologies provide relatively limited resolutions. For example, conventional x-ray crystallography provides a resolution in the range of 1.5 Angstroms to 3.0 Angstroms. While the limited resolution is generally suitable for relatively large atoms, smaller features are not readily discernable. As a result, conventional virtual representations of relatively large molecules tend to be “fuzzy.” Even with improved resolution, an imaged crystalline structure may, nevertheless, not be accurate because the molecule is not in its natural state.

What are needed are methods and systems for improving virtual representations of large molecules, such as those generated from protein crystallization structures.

### BRIEF SUMMARY OF THE INVENTION

The present invention is directed to methods and systems for improving virtual representations of large molecules, such as those generated from protein crystallization structures.

The invention includes assessing one or more features of the virtual representation of the protein. One or more of a variety of assessments can be performed including, without limitation, analyzing for completeness (e.g., missing and/or incomplete residues and/or side chains), identifying missing (typically smaller) atoms, determining ionization states (i.e., protonated, deprotonated or neutral), determining orientation of bonds, and/or identifying atoms that are not part of the protein.

The invention further includes modifying the virtual representation of the protein based, at least in part, on the assessment(s). Modification can include, without limitation, refining, improving, tailoring, editing, and/or revising the virtual representation of the protein.

The invention provides a “prepared” virtual representation of the target protein. The prepared virtual representation of the target protein is useful for further in-silico, or computer processing. Further processing can include, without limitation, designing of small molecules that will potentially bind and/or interact with the target protein.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE FIGURES

The present invention will be described with reference to the accompanying drawings. The drawing in which an element first appears is typically indicated by the leftmost digit(s) in the corresponding reference number.

FIG. 1 is a high-level flowchart 100 illustrating a method for preparing a virtual representation of a target protein.

FIG. 2 is a flowchart 200 of optional “preparation” features that can be implemented alone and/or in various combinations with one another.

FIGS. 3A-3G illustrate the first 5 pages of an example 20 page print-out of a computer file for a protein titled, “Hiv Gp41 Core Structure,” obtained from the Protein Data Bank.

FIG. 3H illustrates a portion of the atom information 302 from FIG. 3G.

FIG. 4 illustrates a portion of an example modified virtual representation of a protein.

FIG. 5A is an example of a Ramachandran plot of a virtual representation of a protein, identified by PDB identifier 1CP3 generated with PROCHECK. (PROCHECK References Laskowski R A, MacArthur M W, Moss D S & Thornton J M PROCHECK: a program to check the stereochemical quality of protein structures. (1993). J Appl. Cryst., 26, 283-291.; Morris A L, MacArthur M W, Hutchinson E G & Thornton J M. Stereochemical quality of protein structure coordinates. (1992) Proteins, 12, 345-364)

FIG. 5B is a Ramachandran plot, generated with PROCHECK, of a modified virtual representation of the 1CP3 protein, identified here as 1cp3p1.

FIG. 6 is a block diagram of an example computer system 600, in which a virtual representation of a protein can be prepared in accordance with the invention.

FIG. 7A is an example of a Ramachandran plot, generated with PROCHECK, of virtual representation of another protein, identified by PDB identifier II3O.

FIG. 7B is a Ramachandran plot, generated with PROCHECK, of a modified virtual representation of the II3O protein, identified here as 1i3op1.

FIG. 8 is a high level diagram illustrating a system for preparing a virtual representation of a target protein.

FIG. 9 demonstrates that certain amino acid side chains can have various conformational states.

### DETAILED DESCRIPTION OF THE INVENTION

Table of Contents

| | |
|---|---|
| I. | Introduction |
| II. | Methods for Preparing Virtual Representations of Molecules |
| III. | System for Preparing Virtual Representations of Molecules |
| IV. | Computer Program Implementations |
| V. | Conclusion |

### I. Introduction

The present invention is directed to methods and systems of preparing virtual representations of molecules. As used herein, the term, “preparing,” can include, without limitation, assessing one or more conditions and/or features of a virtual representation of a molecule and modifying the virtual representation, as appropriate, to improve resolution or detail. For example, preparing can include, without limitation, analyzing a virtual representation for completeness and completing and/or terminating incomplete sections, identifying and adding missing (typically smaller) atoms, identifying and adding hydrogen bonds, assigning/refining orientation of hydrogen bonds, and/or determining/assigning ionization states (i.e., protonated or not) of hydrogen bonds. Modifications to a virtual representation of a molecule can include, without limitation, refining, improving, tailoring, editing, and/or revising the virtual representation.

Of particular interest here are relatively large molecules, such as proteins. For the remainder of this specification, the invention shall be described in terms of preparation of a virtual representation of a protein molecule. The invention is not, however, limited to preparation of a virtual representation of a protein molecule. Based on the description herein, one skilled in the relevant art(s) will understand that the invention can be applied to virtual representations of other types of molecules as well, including, without limitation, virtual representations of individual amino acids, peptides, polypeptides and other types of molecules.

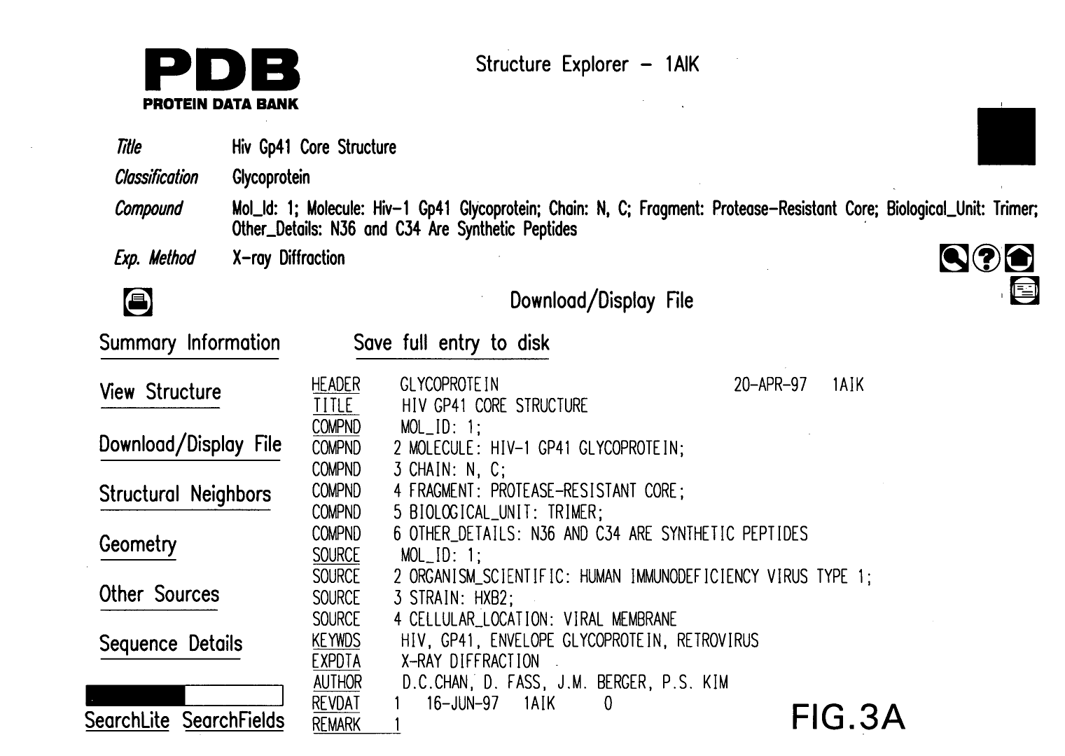

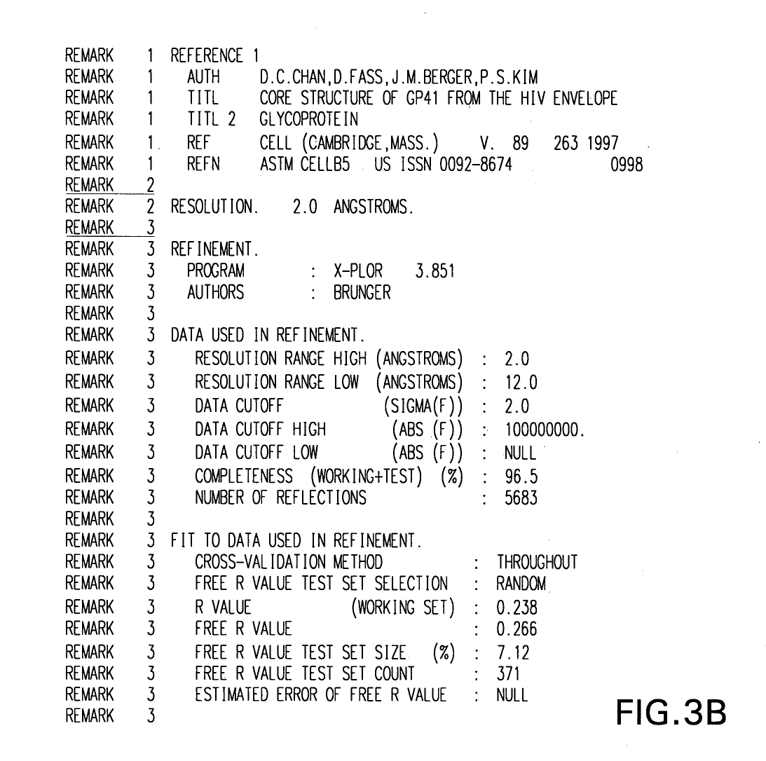

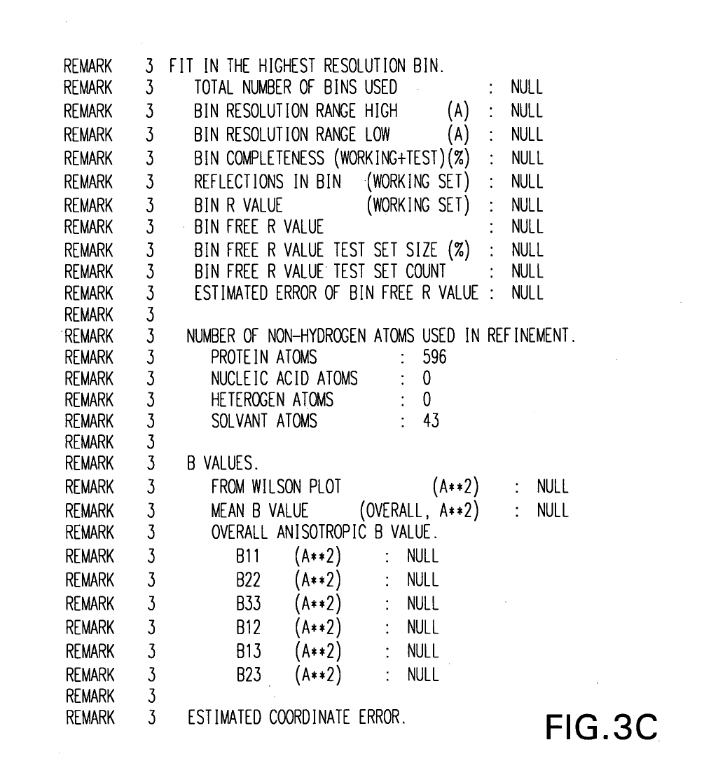

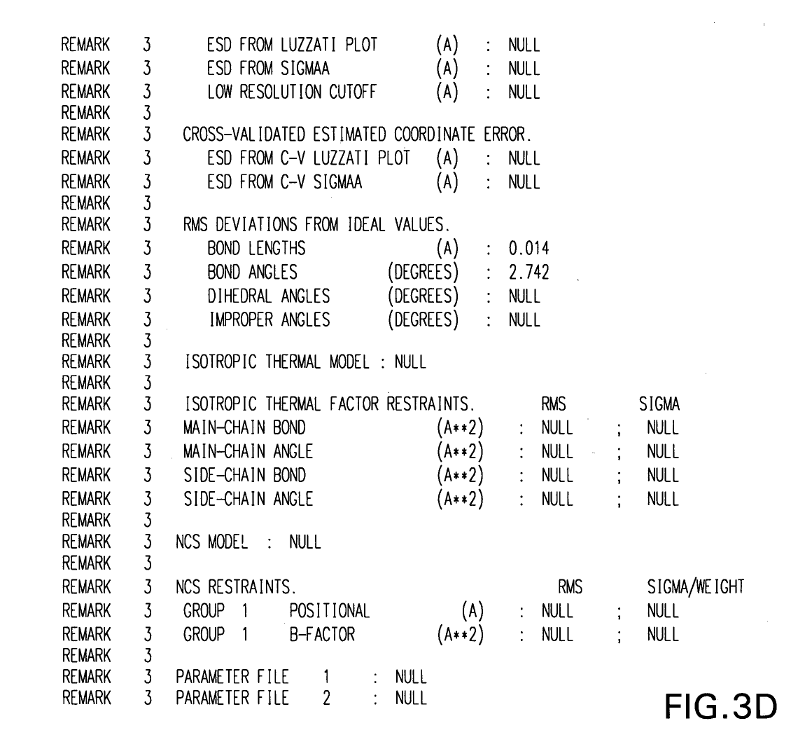

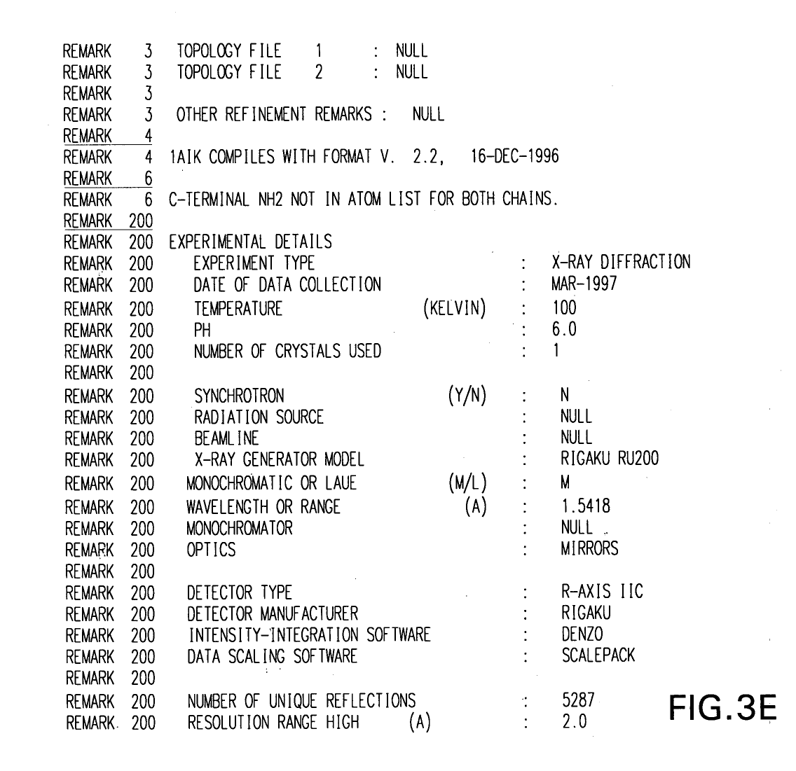

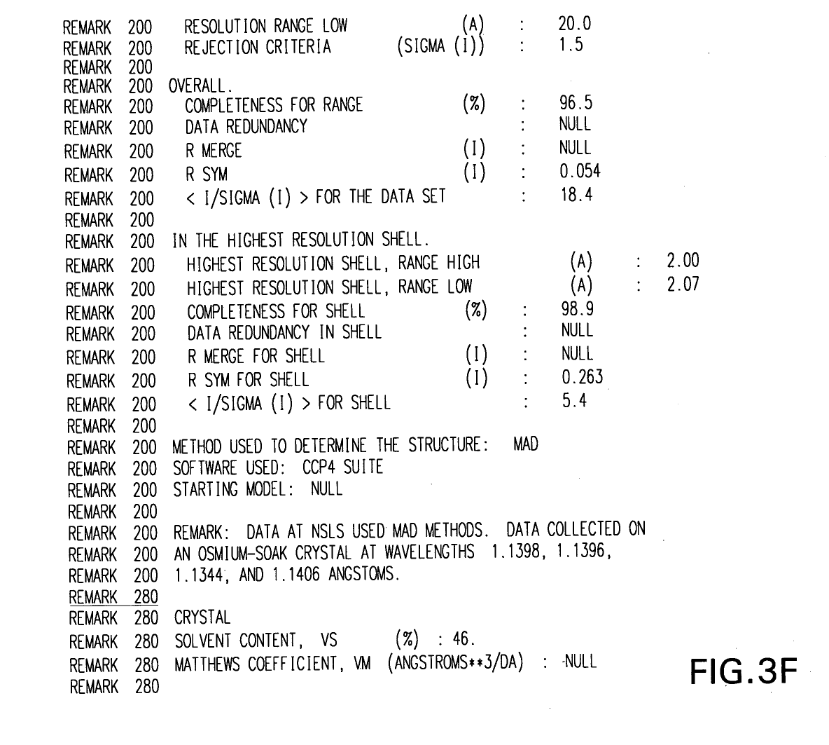

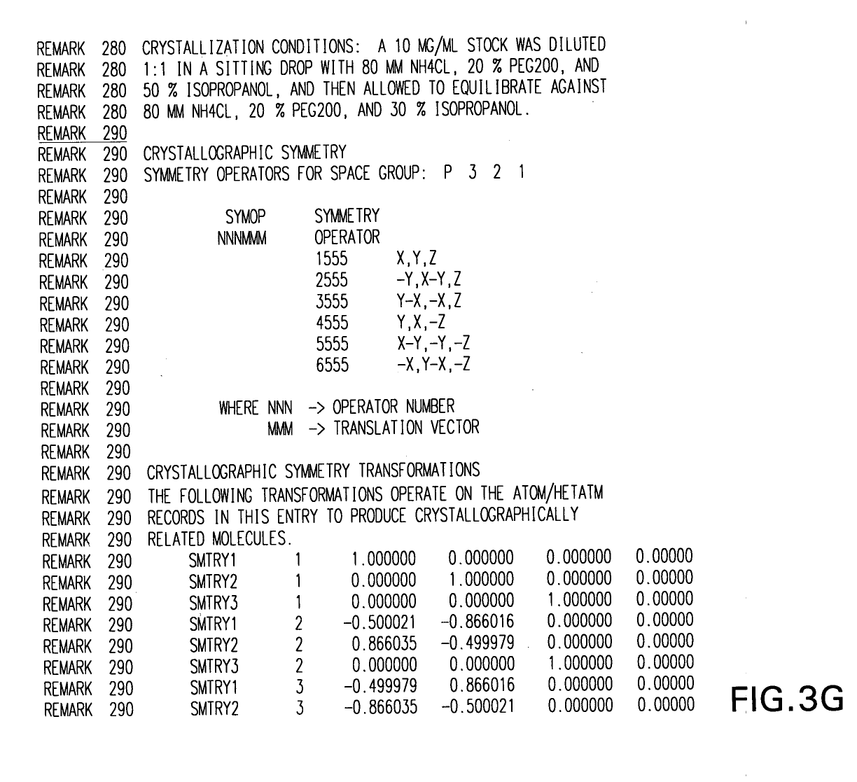

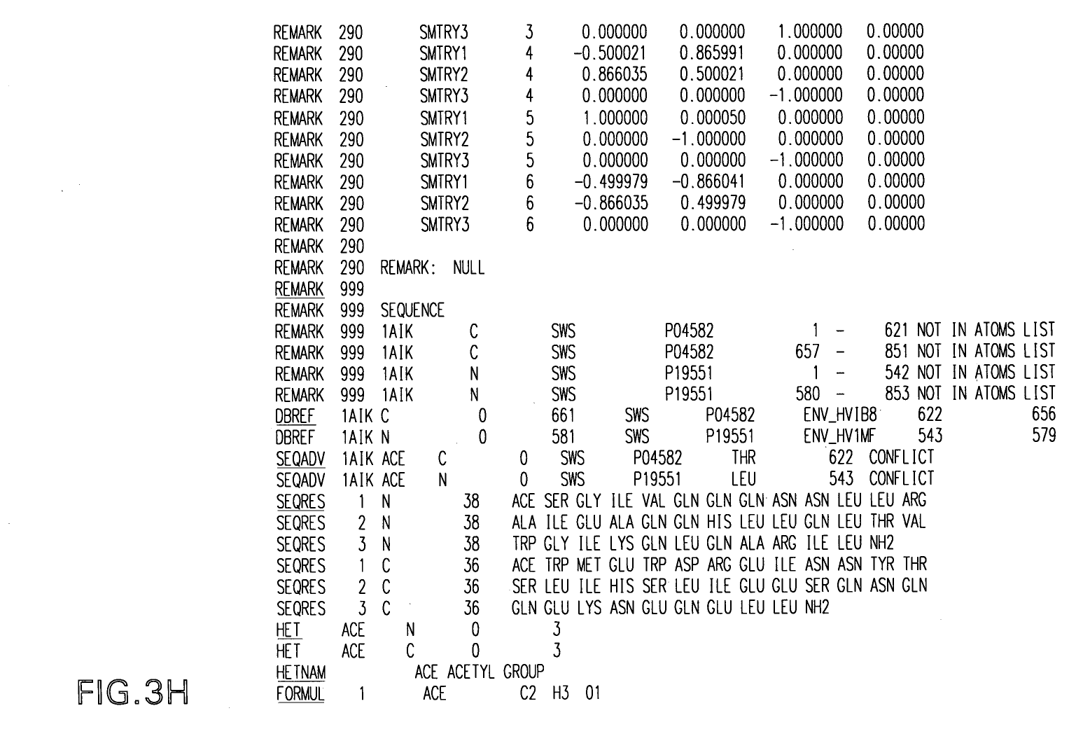

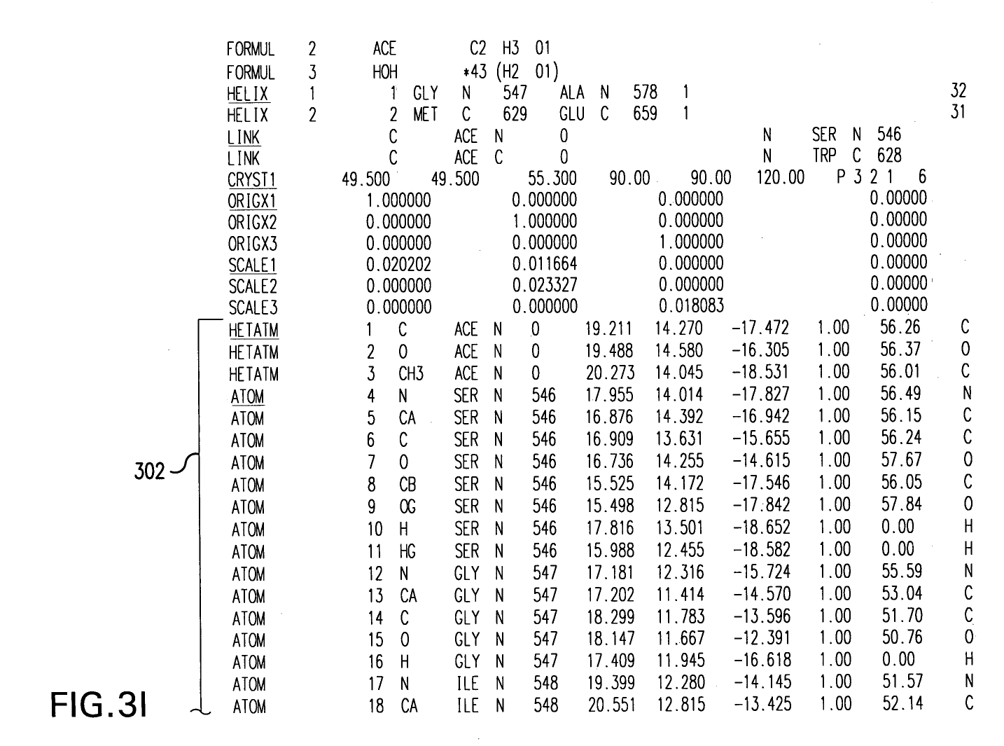

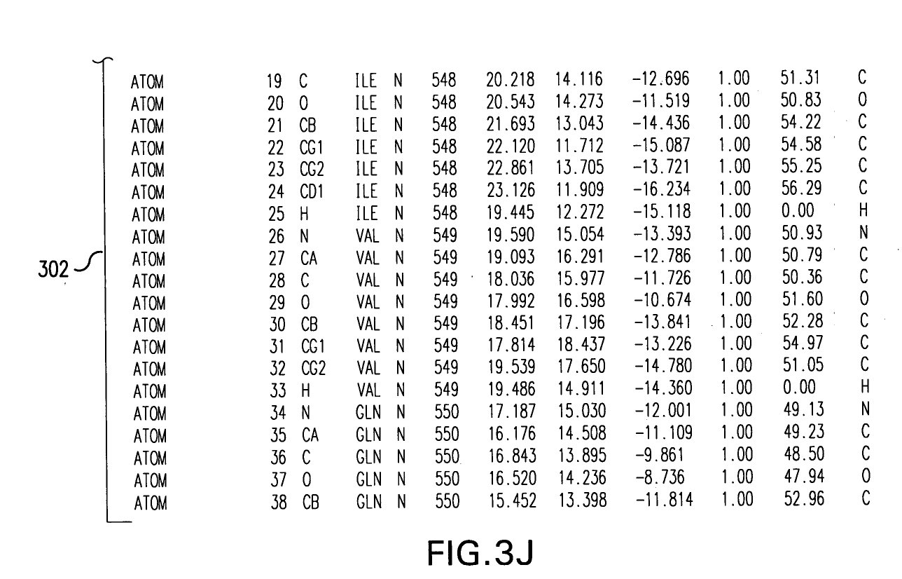

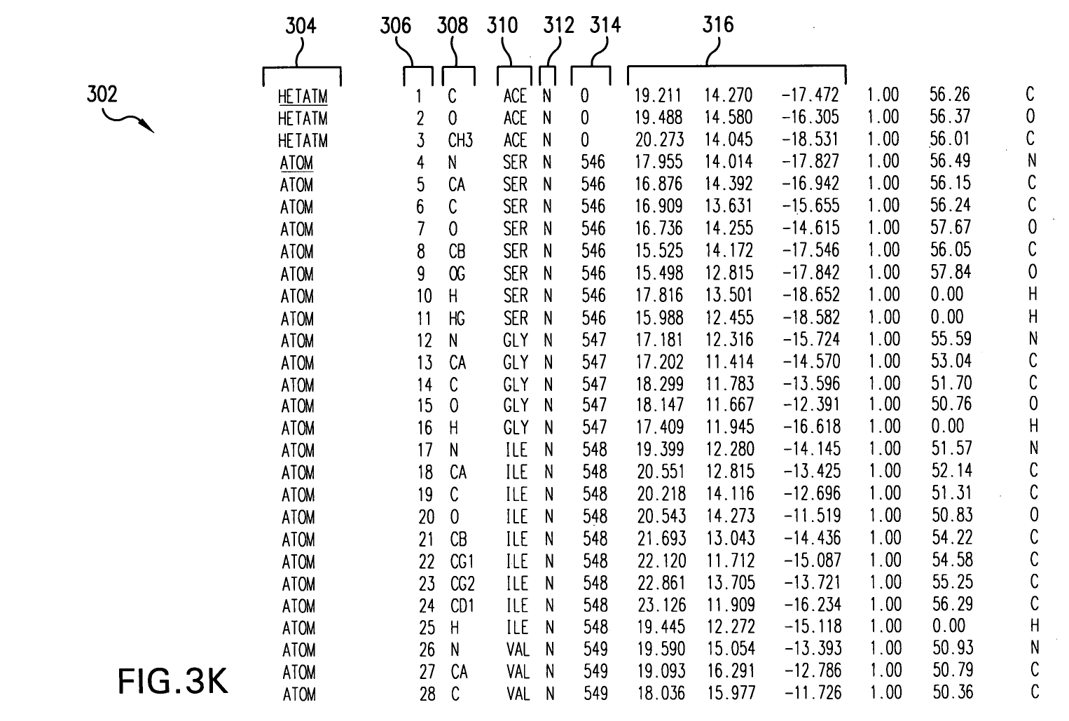

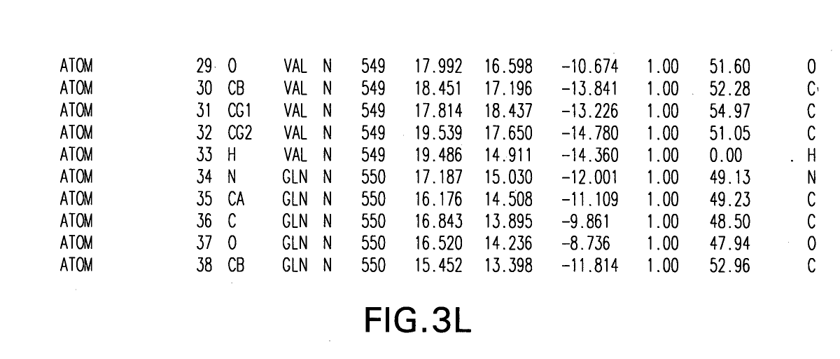

Virtual representations of proteins are stored in one or more electronic or computer files. For example, FIGS. 3A-3G illustrate the first 5 pages of a print-out of a computer file for a protein titled, “Hiv GP41 Core Structure.” The example computer file was obtained from the PDB, cited above. The example computer file corresponds to PDB identifier 1AIK. FIGS. 3A-3F include various remarks and information related to the Hiv GP41 Core Structure. Atom information 302 begins on FIG. 3G. A portion of the atom information 302 from FIG. 3G is reproduced in FIG. 3H. Columns of information contained within the atom information 302 are now described with reference to FIG. 3H.

In FIG. 3H, atom information 302 includes a remarks column 304, an atom identifier column 306, an atom information column 308, a residue name identifier column 310, a protein chain identifier column 312, a residue number identifier column 314, and atom coordinate columns 316, which are described below.

In the remarks column 304, the term “atom” identifies the corresponding row of information as pertaining to an atom. The atom identifier column 306 provides a unique identification number for each listed atom. The atom information column 308 provides a corresponding abbreviated name for each listed atom, as would be understood by one skilled in the relevant art(s). The atom coordinates column 316 provides three dimensional coordinates (e.g., x, y, z coordinates) for corresponding atoms.

Atoms of a protein are generally associated with residues, or amino acids of the protein. Amino acid structures are well known to those skilled in the relevant art(s). The residue name identifier column 310 identifies the residue with which the corresponding atom is associated. The residues are identified by 3 alpha-characters, as would be understood by one skilled in the relevant art(s). The residue number identifier column 314 provides sequential residue numbers for the corresponding atoms.

Conventional virtual representations of proteins suffer from a number of disadvantages. For example, one or more residues of a protein may be incomplete or entirely missing from the atom information 302. This can occur as a result of an incomplete sample and/or other causes associated with imaging of the protein. In addition, some residues have one or more side chains that include one or more atoms. One or more side chains or portions thereof may be missing from the atom information 302.

One or more atoms of a protein may not be included in the atom information 302. For example, smaller atoms, such as hydrogen, are too small to be seen by conventional imaging systems, (i.e., the imaging systems do not detect sufficient density). For example, residue number 546 in the residue number identifier column 314, is identified as SER (“serine”) in the residue name identifier column 310. A serine residue normally includes 5 hydrogen atoms, as is well known to those skilled in the relevant art(s). In the example of FIG. 3H, however, only two hydrogen atoms (i.e., atom numbers 10 and 11) are listed for the serine residue 546.

Even if hydrogen atoms are included in the atom information 302, their orientation may not be correct. For example, proteins are often crystallized prior to imaging. When a protein is crystallized, hydrogen atoms may not exist in their normal orientation or state. At typical resolutions of the protein crystal structure, 1.5-3.0 Angstroms, the placement of the hydrogen atoms based on the electron density is usually ambiguous. Such ambiguity is readily understood by one of ordinary skill in the relevant art(s).

Other drawbacks to conventional virtual representations of proteins can include missing or incorrect protonation states, presence of atoms that are not part of the protein (e.g., water atoms, metals, etc., collectively referred to herein as “hetero atoms, or “HETs”), and/or human error relating to data entry, coding, and/or assumptions concerning the protein.

Accordingly, the present invention is directed to methods and systems for preparing virtual representations of proteins. The improved virtual representations of proteins are more suitable for in-silico processing than conventional virtual representations of proteins.

II. Methods for Preparing Virtual Representations of Molecules

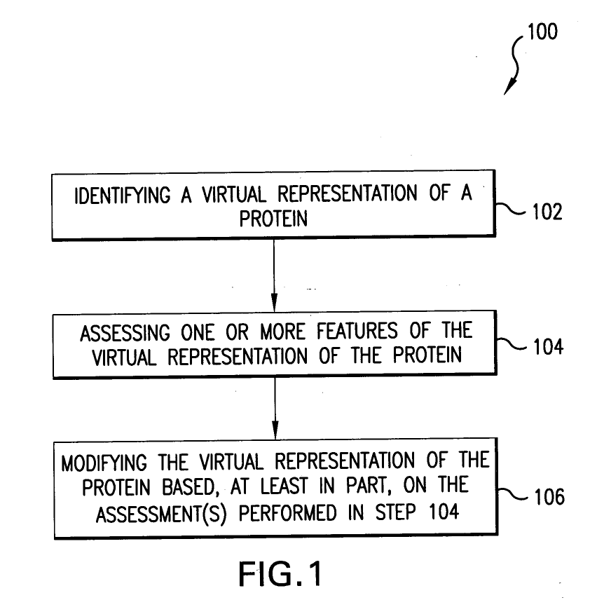

FIG. 1 is a high-level flowchart 100 illustrating a method for preparing a virtual representation of a target protein. The flowchart 100 begins with step 102, which includes identifying a virtual representation of a protein. Step 102 can include identifying one or more computer files that include information related to the protein. The virtual representation of the protein can be obtained from, for example, the PDB, cited and incorporated by reference in its entirety above.

The virtual representation of the protein typically includes a virtual three dimensional (“3D”) structure of a protein, or portions thereof, and a sequence listing of atoms and/or residues of the protein. The virtual 3D structure can be obtained from one or more of a variety of sources and/or methods. For example, the virtual 3D structure can be obtained experimentally, such as by x-ray and/or nuclear magnetic resonance imaging (“NMR”). Alternatively, or additionally, the virtual 3D structure can be obtained from an information source, such as, for example, the publicly available PDB, cited above. The PDB typically provides coordinates of heavy atoms (e.g., carbon, oxygen, nitrogen and sulfur) within a protein, as illustrated by atom coordinates 316 in FIG. 3H. The PDB generally does not, however, provide coordinates for smaller atoms, such as hydrogen. Virtual 3D structures can also be obtained from homology processing.

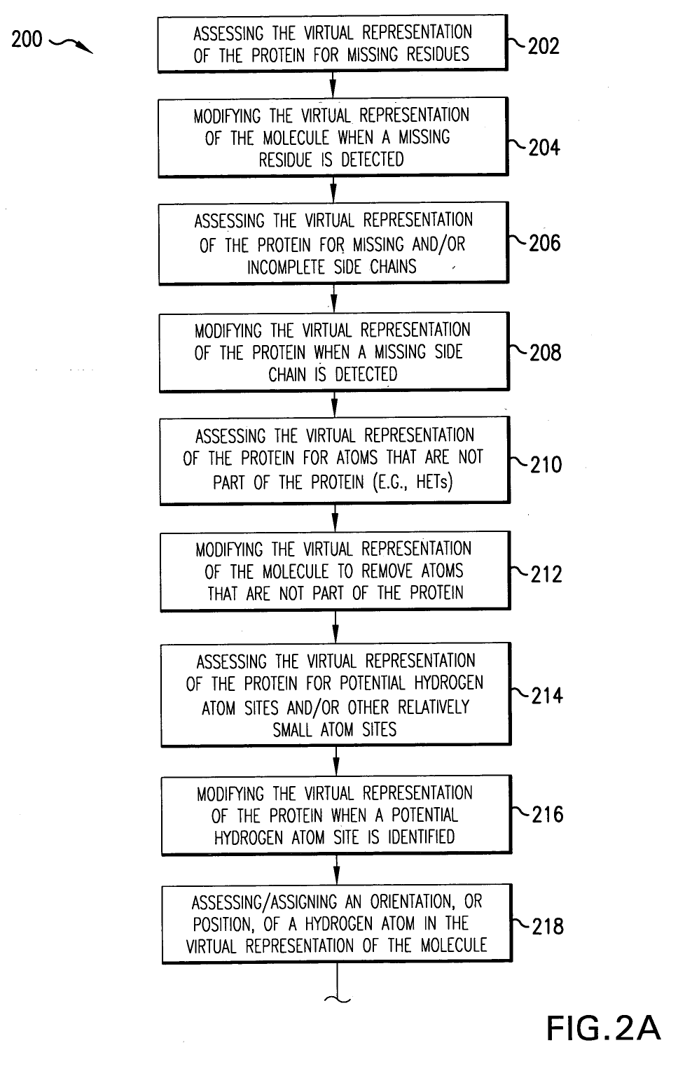

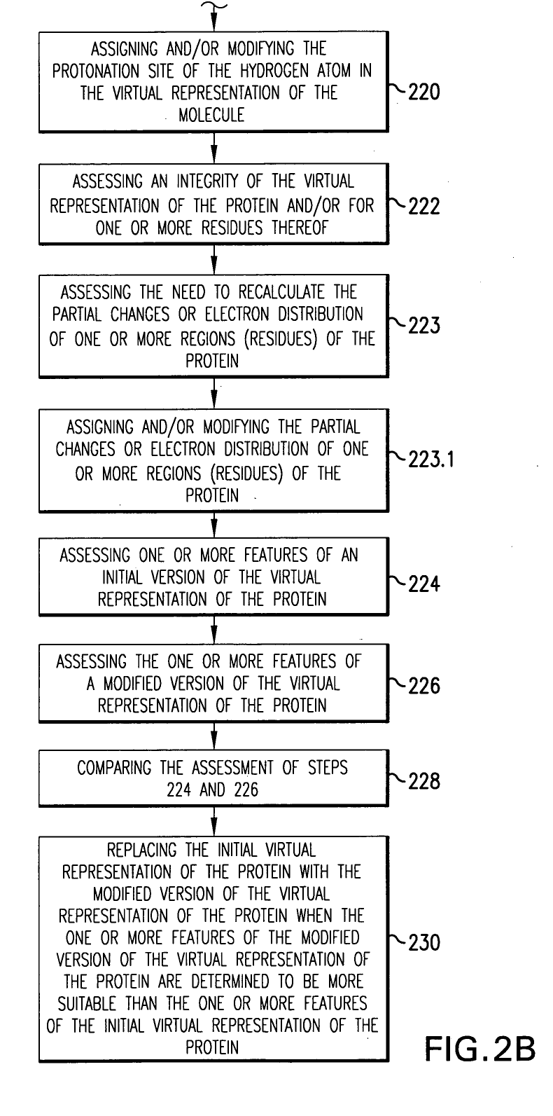

After the virtual representation of the protein has been identified, processing proceeds to step 104, which includes assessing one or more features of the virtual representation of the protein. One or more of a variety of assessments can be performed including, without limitation, analyzing for completeness (e.g., missing and/or incomplete residues and/or side chains), identifying missing (typically smaller) atoms, determining ionization states (i.e., protonated or not), determining orientation of bonds, and/or identifying atoms that are not part of the protein. Example assessments are described below with respect to FIG. 2.

After assessing one or more features of the virtual representation of the protein, processing proceeds to step 106, which includes modifying the virtual representation of the protein based, at least in part, on the assessment(s) performed in step 104. Step 106 can include, without limitation, refining, improving, tailoring, editing, and/or revising the virtual representation of the protein.

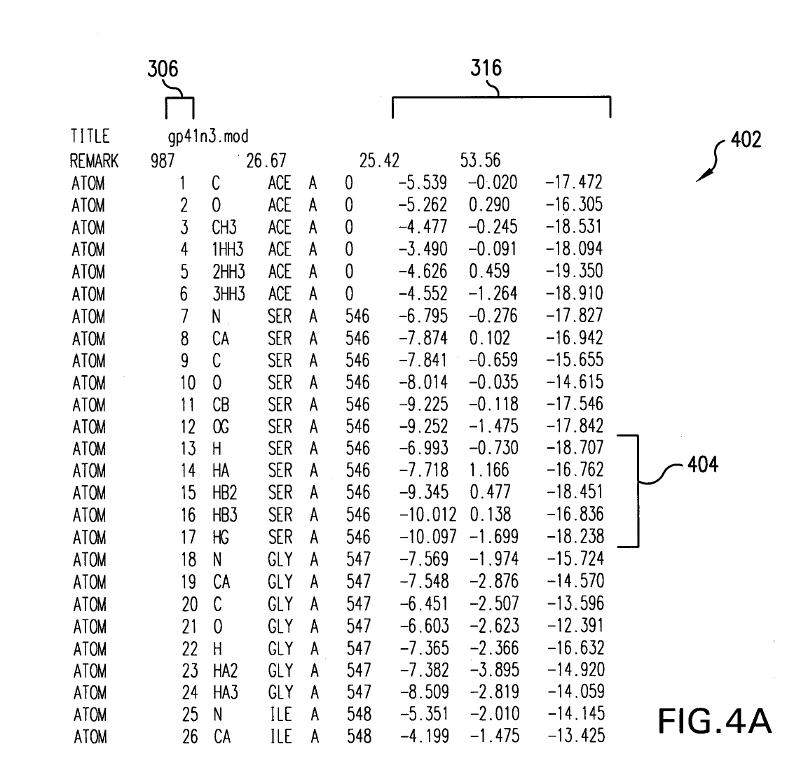

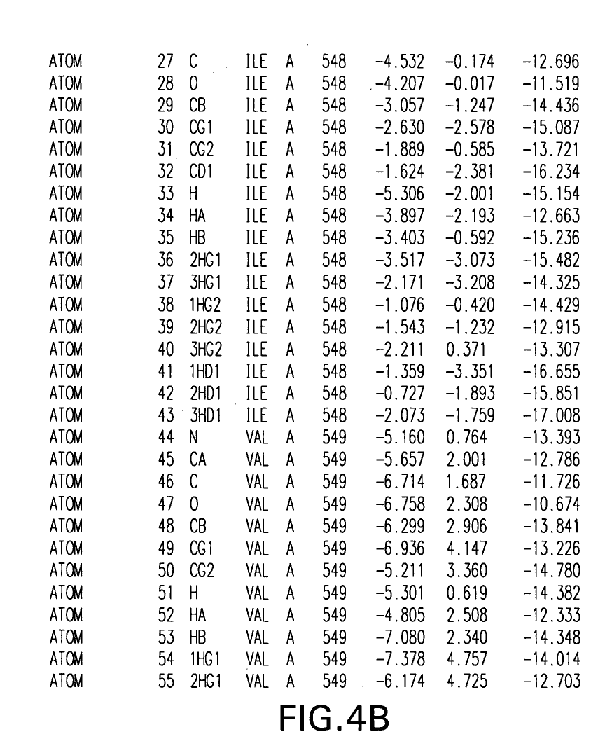

The process illustrated in the flowchart 100 provides a “prepared” virtual representation of a target protein. FIG. 4 illustrates a portion of an example modified virtual representation of a protein. In FIG. 4, atom information 402 is a modified version of a portion of the atom information 302 from FIG. 3H. For example, in FIG. 4, the serine residue 546 has been modified at rows 404 to include the three missing hydrogen atoms that were discussed above. The three added hydrogen atoms correspond to atom numbers 14 through 16 in the atom number column 306 of FIG. 4. The three added hydrogen atoms have been assigned three dimensional coordinates in coordinate column 316 of FIG. 4. Other modifications to the atom information 302 have also been made in the example of FIG. 4. The invention is not, however, limited to the example modifications of FIG. 4.

The prepared virtual representation of the target protein is useful for further in-silico, or computer processing. Further processing can include, without limitation, designing small molecules that will potentially bind and/or interact with the target protein.

FIG. 2 is a flowchart 200 of optional “preparation” features that can be implemented alone and/or in various combinations with one another as part of steps 104 and/or 106. The invention is not, however, limited to the example features illustrated in the flowchart 200. Based on the description herein, one skilled in the relevant art(s) will understand that the present invention can be implemented with various sub-sets of features illustrated in the flowchart 200 and/or with other features, alone and/or in combination with one or more features illustrated in the flowchart 200. The features illustrated in the flowchart 200 are not necessarily performed in the order illustrated in FIG. 2.

The flowchart 200 begins with step 202, which includes assessing the virtual representation of the protein for missing residues. Missing residues can result from an incomplete sample and/or other causes associated with imaging of the protein. Missing residues can also result where a missing side chain causes a residue to be misnamed. Missing residues can be identified from one or more missing sequential numbers in the residue number identifier column 312. Additionally, or alternatively, missing residues may be noted in remarks and/or header information of the virtual representation of the protein. Missing residues can also be identified by comparing the sequence listing for the protein with the virtual representation of the protein.

Step 204 includes modifying the virtual representation of the protein when a missing residue is detected. Where a relatively small number of sequential residues are missing, step 204 can include adding the missing residue(s) into the atom information 302. This can include listing atoms of the residue along with coordinates for the atom in the atom information 302.

Where a relatively large segment of the protein is missing, or where the missing residue(s) occur at location that is relatively remote from a location of interest (e.g., a potential binding site) however, step 204 can include capping exposed ends. Capping is performed by adding one or more relatively neutralizing atoms to the exposed ends.

Step 206 includes assessing the virtual representation of the protein for missing and/or incomplete side chains. Missing and/or incomplete side chains can be identified in a variety of ways. For example, and without limitation, missing and/or incomplete side chains can be identified in remarks and/or header information of the virtual representation of the protein. Missing and/or incomplete side chains can also be identified by comparing residues in the atom information 302 with residue templates that include side chain templates. A residue template should include at least the relatively heavy atoms of the residue. Missing and/or incomplete side chains can also be detected by searching for carboxy and/or amino ends.

Step 208 includes modifying the virtual representation of the protein when a missing side chain is detected. This can include listing missing side chain atoms and their coordinates in the atom information 302. Alternatively, if a missing portion is deemed to be not important because its position is relatively distant from a site of interest (e.g., binding or docking site), the ends can be capped. Similarly, if a substantial portion of the protein is missing, exposed ends can be capped.

In some situations, there may be multiple possible solutions and/or alternative configurations for side chains. In such cases, step 206 can include identifying, determining, and/or proposing multiple possible solutions and/or alternative configurations for side chains. Similarly, step 208 can include selecting a solution from the possible solutions and/or alternative configurations.

For example, side chains can be compared to known side chains that have alternative configurations. Potential solutions and/or alternative configurations can be identified from a table of known solutions, for example.

Potential solutions can also be determined by considering surrounding features that may affect the configuration (e.g., potential donors and receptors) of the atoms that make up the residue.

Step 210 includes assessing the virtual representation of the protein for atoms that are not part of the protein. For example, metals, water and/or other atoms not part of the target protein (i.e., HETs), may have been introduced during a crystallization process. HETs can be identified, for example, by examining the remarks column 304 . In the example of FIG. 3H, for example, HETs are identified with the term, “HETATM.”

Step 212 includes modifying the virtual representation of the protein to remove atoms that are not part of the protein. Certain enzymes require metals. Thus, in certain circumstances, such metals are left in the virtual representation of the protein.

Step 214 includes assessing the virtual representation of the protein for potential hydrogen atom sites and/or other relatively small atom sites. Potential hydrogen atom sites can be identified by the geometry of the protein. For example, hydrogen atoms are typically located relative to carbon atoms. Thus, carbon atoms provide an indication that a hydrogen atom may be missing. Alternatively, or additionally, residues listed in the atom information 302 are compared to residue templates that include known hydrogen atom sites. For example, above it was noted that the serine residue 546 in FIG. 3H is missing three hydrogen atoms.

Step 216 includes modifying the virtual representation of the protein when a potential hydrogen atom site is identified. Step 216 can include, for example, listing missing hydrogen atoms and their coordinate in the remarks column 304, as was done in rows 404 of FIG. 4.

The exact position of the hydrogen atoms are not generally known because the atoms to which they are attached are often able to rotate. Accordingly, step 218 includes assessing an orientation, or position, of a hydrogen atom in the virtual representation of the protein. Step 218 can be performed for pre-existing hydrogen atoms listed in the atom information 302 and/or for hydrogen atoms added to the atom information 302 in step 216. Step 218 can be performed, for example, by selecting a set of coordinates from a table of possible known coordinates.

In an embodiment, step 218 includes assigning initial coordinates to a hydrogen atom and thereafter, assessing and refining the orientation of the hydrogen atom in view of surrounding features and/or influences. In an embodiment, the subsequent assessing and/or refining is performed with a simulated annealing process. Alternatively, and/or additionally, the assessing and/or refining is performed with one or more of a variety of other search and energy evaluation methods, as would be understood by one skilled in the relevant art(s) based on the description herein. The subsequent assessing and/or refining is typically performed to reduce an energy state associated with the hydrogen atom and the surrounding features and/or influences, such as surrounding atoms.

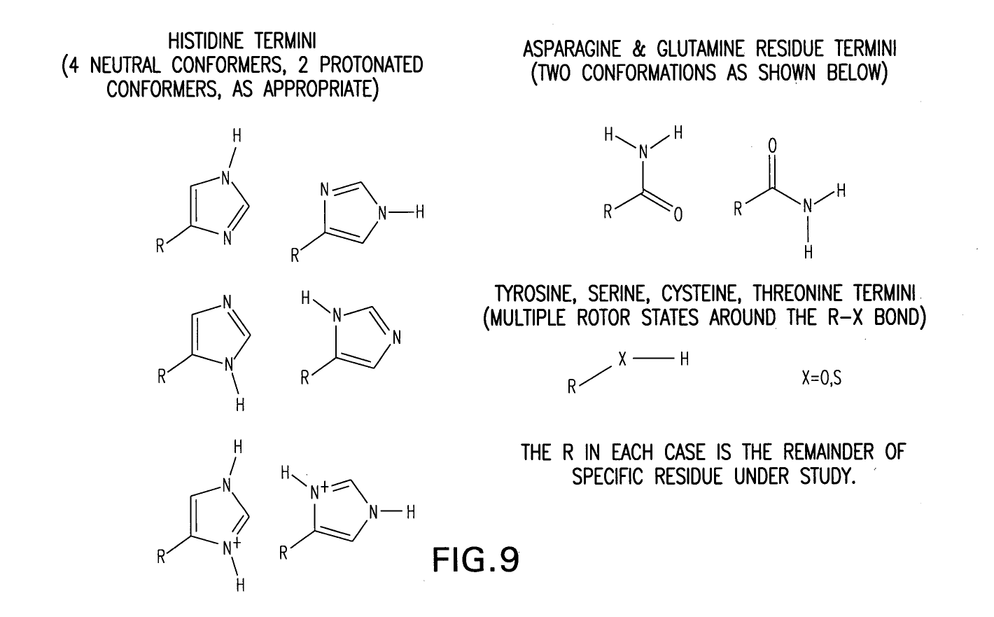

For example, in an embodiment of the search and evaluation process, side chains containing functional groups capable of multiple conformations are sought out and evaluated to determine an energetically favorable orientation/conformation of those residues in relation to the rest of the protein. Preferably, the final orientation/conformation is the most energetically favorable. Hydrogen bonding, electrostatic, and other noncovalent interactions between such residues and the remainder of the protein are evaluated to determine the optimal orientation/confirmation. Examples of residues sought out in the seek and evaluation process include, but are not limited to, histidine, asparagine, glutamine, tyrosine, serine, cysteine and threonine. FIG. 9 illustrates the various conformers and protonation states of histidine, and conformations of asparagine and glutamine, and the R—X bond for which multiple rotors can be considered for the tyrosine, serine, cysteine and threonine.

Step 220 includes assigning and/or modifying the protonation state of the residue in the virtual representation of the protein. A local environment can be considered when determining whether a residue should be protonated, deprotonated or neutral. A local environment can be considered as described in one or more of the following references:

Mehler, E. L., et al., “A Self-Consistent, Microenvironment Modulated Screened Coulomb Potential Approximation to Calculate pH-Dependent Electrostatic Effects in Proteins,” Biophysical Journal, Volume 75, pp. 3-22, (July 1999); and

Ondrechen, M. J., et al., “THEMATICS: A Simple Computational Predictor of Enzyme Function from Structure,” PNAS, Volume 98, No. 22, pp. 12473-12478, (Oct. 23, 2001); both of which are incorporated herein by reference in their entireties.

Step 222 includes assessing the integrity of the virtual representation of the protein and/or for one or more residues thereof. Step 222 can include, for example, assessing an energy state of the virtual representation of the protein and/or for one or more residues thereof. Step 222 can include, for example, modifying coordinates 316 of one or more atoms in the atom information 302 to improve integrity.

Step 222 also includes assessing the energy state of the virtual representation of the protein. A protein structure obtained from the protein data bank can have high energy regions as a result in part, but not limited to, close atom contacts. For example, when two atoms not connected by covalent bonds are closer to one another than the sum of their van der Waals radii, there is considered to be a steric clash. This type of steric clash is typically considered by those skilled in the art to be a high energy interaction. One possible way to relieve this steric strain is to perform energy minimization of the protein. This can optionally be performed in a localized region or over all of the atoms of the protein. This minimization can be performed with an all atom (hydrogen atoms on all heavy atoms to fill their valences as appropriate) approach or as a united atom approach (hydrogen atoms only on the heteroatoms, e.g. oxygen, nitrogen and sulfur). There are other ways to relieve these high energy regions of the protein which are known by those skilled in the art.

Step 223 includes the optional step of assessing the need to recalculate the partial charges or electron distribution of one or more regions (residues) of the protein. Step 223.1 is also optional and includes assigning and/or modifying the partial charges or electron distribution of one or more regions (residues) of the protein, if necessary. Step 223.1 results in a modified protein data file that contains an additional field for the charges of the atoms in the protein. This additional field may optionally be blank or contains the set of assigned charges.

Typically the partial charges of the atoms of the protein are taken from a force field file, for example the AMBER94 or AMBER99 force field. These charges are in general adequate for general circumstances. On occasion a protein will present a situation where there is a high concentration of charge, for example, when a metal is present. During this situation it is necessary to determine the effect of the metal's charge on the protein. The metal will have the effect of polarizing the local environment significantly, and the long range environment to a lesser degree. As a result of this polarization the formal charge on the metal will change with a corresponding change occurring to the atoms of the neighboring residues. The net effect will be to spread out the charge over the local or, optionally, the global protein environment. The result will be a protein structure more approximately prepared for use in structure based ligand (drug) design.

The methods used to modify the charges are well known and would be readily apparent to one of ordinary skill in the art. An example of one approach would be to perform an ab initio (quantum mechanical) calculation of the region of interest which encompasses all of the atoms in the desired region using a program such as Gaussian (for example, M. J. Frisch et al., Gaussian 98 (Gaussian, Inc., Pittsburgh Pa. 1998). A variety of basis sets can be used to calculate the wavefunction of the region under study and to optionally optimize the structure. An example of a basis set which yields acceptable partial charges is 6-31G* or 6-31G**. After an appropriate wavefunction is calculated as determined by one skilled in the art, one would run a charge fitting algorithm known by one skilled in the art (Mulliken, R. S., Journal of Chemical Physics 36:3428-39) (1962); Chipot, Christophe, et al., Journal of Physical Chemistry 96(25):10276-84); Bachrach, Steven M., Reviews in Computational Chemistry 5:171-227 (1994); Wilberg, Kenneth B. & Rablen, Paul R., Journal of Computational Chemistry 14(12):1504-18 (1993)). The resulting partial changes can then be incorporated into the protein structure file for use in subsequent simulations. Any downstream computational tool would be required to read the atomic changes from the protein structure file. Optionally, additional methods of providing the charges are known to one skilled in the art.

The invention further includes optional “before” and “after” comparisons that determine whether a modified virtual representation of a protein is a more suitable representation of the protein than an initial virtual representation of the protein. When the quality of the modified virtual representation of the protein is determined to be more suitable than the quality of the initial virtual representation of a protein, the initial virtual representation of the protein is replaced with the modified virtual representation of the protein.

Accordingly, step 224 includes assessing one or more features of an initial virtual representation of the protein. Step 224 can include, for example, assessing the energy state of the protein and/or the energy state of one or more residues thereof.

Step 226 includes assessing the one or more features of a modified version of the virtual representation of the protein.

Step 228 includes comparing the assessments of steps 224 and 226.

Step 230 includes replacing the initial virtual representation of the protein with the modified version of the virtual representation of the protein when the one or more features of the modified version of the virtual representation of the protein are determined to be more suitable than the one or more features of the initial virtual representation of the protein.

Step 230 can be performed in one or more of a variety of ways. For example, and without limitation, step 230 can include weighing one or more features.

The one or more features can include, without limitation, one or more of the following example features:

one or more stereochemical parameters of the molecule;

geometry of residues of the molecule;

planarity of the molecule;

dihedral angles of the molecule;

chirality of the molecule;

non-bonded interactions of the molecule;

main-chain hydrogen bonds of the molecule;

disulphide bonds of the molecule.

Steps 224 and 226 can be performed with, for example, a commercially available computer program known as ProCheck, available at http://www.biochem.ucl.ac.uk/˜roman/procheck/procheck.html, incorporated herein by reference in its entirety. ProCheck assesses stereochemical quality of a protein structure, and produces a number of PostScript plots analyzing overall and residue-by-residue geometry. Alternatively, steps 224 and 226 can be performed with one or more other computer programs, manually, and/or combinations thereof.

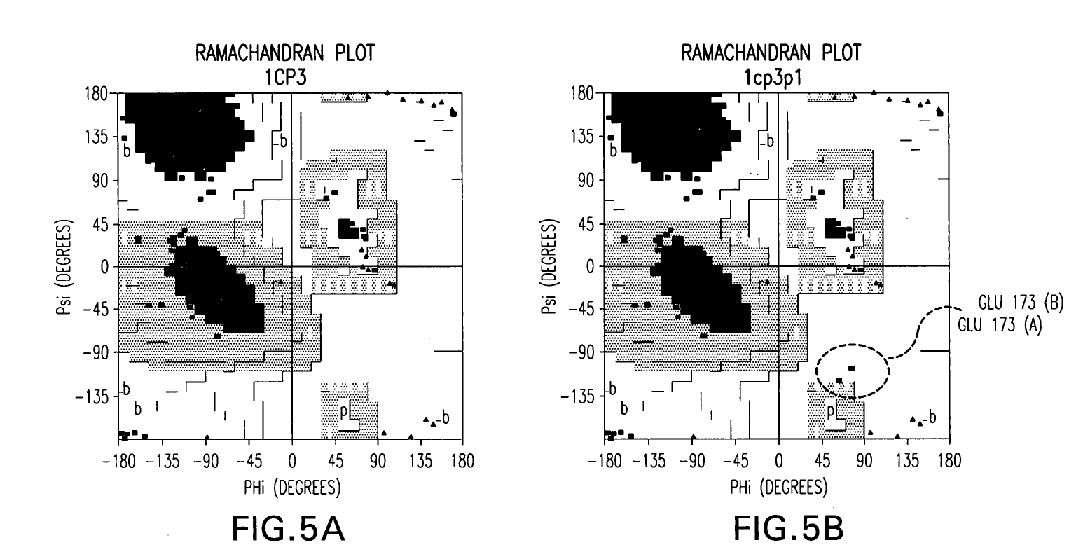

FIGS. 5A is an example of a Ramachandran plot of a virtual representation of a protein, identified by PDB identifier 1CP3. FIGS. 5B is a Ramachandran plot of a modified virtual representation of the 1CP3 protein, identified here as 1cp3p1.

Ramachandran plots show phi-psi torsion angles for residues in the protein. The darkest areas, typically shown in red, correspond to “core” regions representing relatively more favorable combinations of phi-psi values.

The percentage of residues in the “core” regions is a guide to stereochemical quality.

A comparison of the plots of FIGS. 5A and 5B indicate that the modified or prepared virtual representation of the 1CP3 protein is not significantly different from the initial virtual representation of the 1CP3 protein. Thus, the initial virtual representation of the 1CP3 protein can be replaced with the prepared virtual representation of the 1CP3 protein. Had there been a significant adverse difference between the plots of FIGS. 5A and 5B, further analysis could be performed to identify and rectify any problems with the prepared virtual representation of the 1CP3 protein.

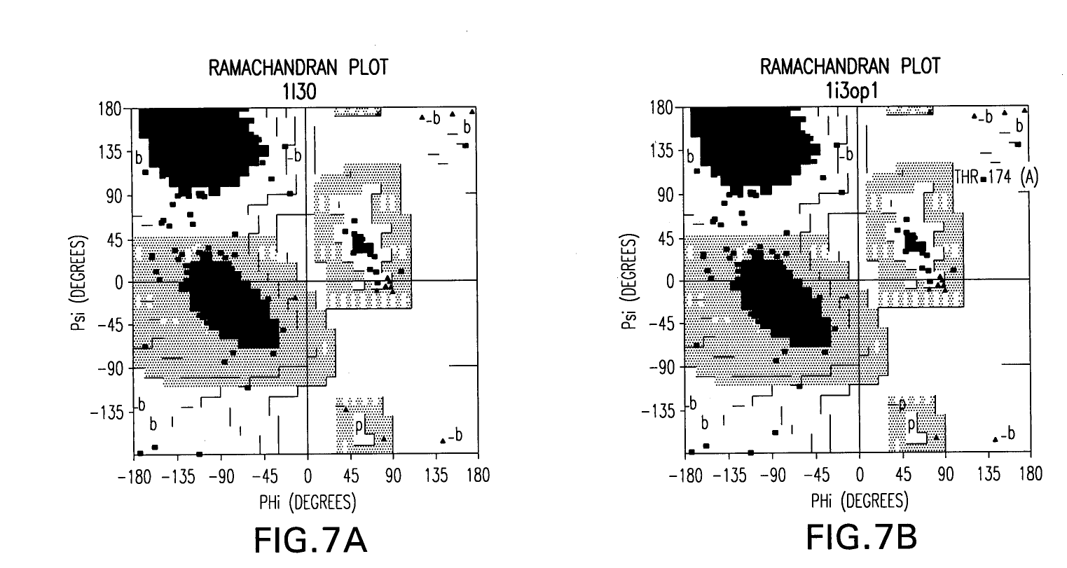

FIG. 7A is an example of a Ramachandran plot of virtual representation of another protein, identified by PDB identifier I130. FIGS. 7B is a Ramachandran plot of a modified virtual representation of the 1I30 protein, identified here as 1i3op1.

The example Ramachandran plots of FIGS. 5A, 5B, 7A, and 7B are provided for example illustration. The invention is not limited to the examples provided herein. Based on the description herein, one skilled in the relevant art(s) will understand that other types of plots and/or comparisons can be performed in accordance with steps 224 and 226.

Another optional step is to minimize the protein. This can be a localized minimization focusing on a particular binding site and/or a more general minimization performed on the entire protein. Minimization can be performed with or without the presence of a small molecule or peptide.

Minimization can be performed using one or more of a variety of conventional and/or yet to be developed minimization techniques, as would be understood by one skilled in the relevant art(s). Minimization can be performed as part of step 106 in FIG. 1, and/or between steps 226 and 228 in FIG. 2, for example.

Alternatively, or additionally, minimization can be performed at any other time during the protein preparation process.

Another optional step is to insert one or more molecules such as, for example, one or more water molecules, into the virtual representation of the protein. A molecule can be inserted during an initial protein preparation process and/or after a subsequent procedure performed on a resulting prepared virtual representation of a protein. When a molecule is added after a subsequent procedure performed on a resulting prepared virtual representation of a protein, the protein preparation process, or a portion thereof, is optionally performed on the modified virtual representation of the protein.

Another optional step is to in-silico mutate one or more residues of the virtual representation of the protein. For example, and without limitation, a leucine residue is mutated into an asparagine residue, a serine residue is mutated to into an alanine residue, and/or a histidine residue is mutated to into a leucine residue. One skilled in the relevant art(s) will understand that other mutations are possible as well. Such other mutations are within the scope and spirit of the invention. In-silico mutations can be performed, for example, to obtain a virtual representation of a different species of a protein for subsequent in-silico processing.

### III. Systems for Preparing Virtual Representations of Molecules

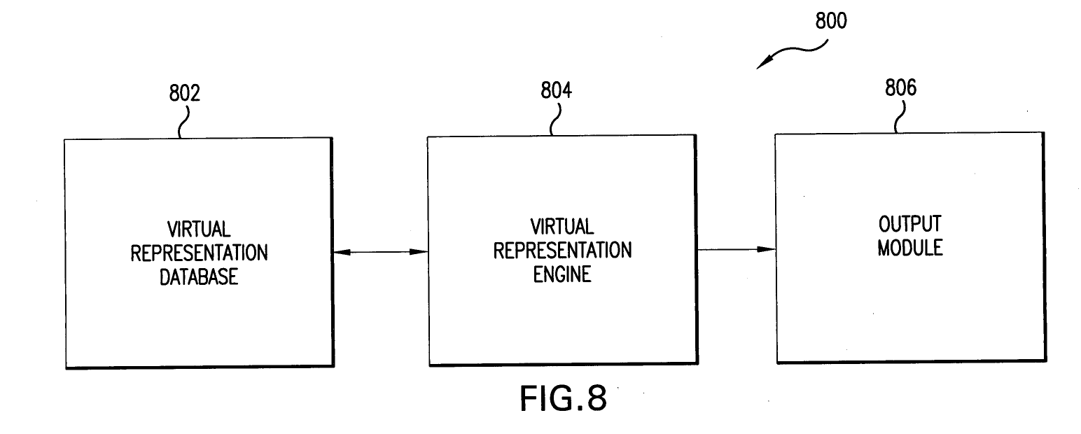

FIG. 8 is a high level diagram illustrating a system 800 for preparing a virtual representation of a target molecule, including but not limited to, protein molecules, amino acids, peptides, polypeptides and other types of molecules.

Referring to FIG. 8, a virtual representation database 802, a virtual representation engine 804 and an output module 806 are shown.

Virtual representation database 802 (hereafter “database 802”) stores virtual representations of molecules that are stored in one or more electronic or computer files. The virtual representation of a protein, for example, typically includes a virtual 3D structure of a protein, or portions thereof, and a sequence listing of atoms and/or residues of the protein. For example, FIGS. 3A-3G illustrate the first 5 pages of a print-out of a computer file for a protein titled, “HIV GP41 Core Structure” that may be stored in database 802.

Virtual representation engine 804 (hereafter “engine 804”) provides the functionality to prepare a virtual representation of a target molecule. The functionality of engine 804 is describe with reference to proteins, but is not limited to proteins. Engine 804 accesses database 802 to identify a virtual representation of a protein. This may involve identifying one or more computer files that include information related to the protein. (See step 102 from FIG. 1).

Once engine 804 identifies the virtual representation of the protein, engine 804 assesses one or more features of the virtual representation of the protein. One or more of a variety of assessments can be performed, as described above with reference to FIG. 1 and steps 104 and 106. Example assessments include analyzing for completeness (e.g., missing and/or incomplete residues and/or side chains), identifying missing (typically smaller) atoms, determining ionization states (i.e., protonated or not), determining orientation of bonds, and/or identifying atoms that are not part of the protein. Engine 804 may also perform all of the example assessments described above with respect to FIG. 2.

After assessing one or more features of the virtual representation of the protein, engine 804 modifies the virtual representation of the protein based, at least in part, on the assessment(s). These modifications can include, without limitation, refining, improving, tailoring, editing, and/or revising the virtual representation of the protein.

The output of engine 804 is a “prepared” virtual representation of a target protein. This “prepared” virtual representation of the target protein may then be displayed via output module 806.

### IV. Computer Program Implementations

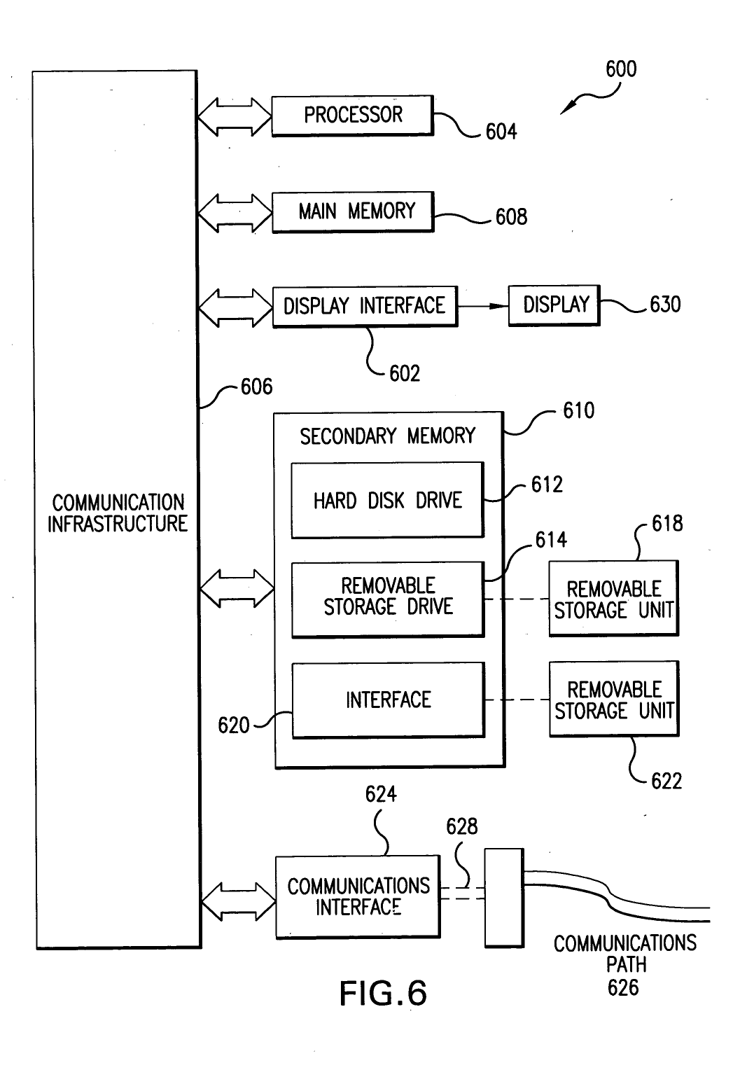

FIG. 6 is a block diagram of an example computer system 600, in which a virtual representation of a protein can be prepared in accordance with the invention. Various embodiments of the invention are described in terms of this example computer system 600. After reading this description, one skilled in the relevant art(s) will understand how to implement the invention using other computer systems and/or computer architectures as well.

The example computer system 600 includes one or more processors 604, which are connected to a communication infrastructure 606. The computer system 600 further includes a main memory 608, which typically includes random access memory (RAM).

The computer system 600 also includes a secondary memory 610. The secondary memory 610 includes a hard disk drive 612, which includes a computer usable storage medium capable of storing computer programs and/or computer usable information. The secondary memory 610 also includes one or more removable storage drives 614. Each removable storage drive 614 is typically associated with one or more removable storage units 618. The removable storage unit(s) 618 include one or more of a floppy disk, a magnetic tape, and an optical disk. Alternatively, or additionally, removable storage unit(s) 618 include one or more other types of removable storage units. Removable storage drive(s) 614 read from and/or write to associated removable storage unit(s) 618.

Secondary memory 610 can also include one or more other storage devices, such as, for example, a removable storage unit 622 and an interface 620. Examples include, without limitation, a program cartridge and cartridge interface (such as that found in video game devices), PCMCIA devices, and a removable memory chip (such as an EPROM, or PROM) and associated socket.

The computer system 600 further includes a communications interface 624, which interfaces between communications infrastructure 606 and a communications path 626. Communications path 626 couples computer system 600 to one or more external systems such as the PDB cited and incorporated by reference in its entirety above. The communications interface 624 processes and/or formats signals 628 between formats suitable for communications infrastructure 606 and formats suitable for communications path 626. The communications interface 624 can include, for example, one or more of a modem, a network interface (such as an Ethernet card), a communications port, a PCMCIA slot and card, and other communications interfaces. The communications path(s) 626 is implemented using one or more of wires, cables, fiber optics lines, telephone lines, cellular phone links, RF links, and other communications mediums. The signals 628 can be electronic, electromagnetic, and/or optical signals. Other types of signals can also be carried.

One or more display interfaces 602 interface one or more displays 130 with the communications infrastructure 602.

The computer system 600 operates on computer programs and computer usable information. Computer programs (also called computer control logic), include computer usable instructions that, when executed by one or more of the processors 604, enable the computer system 600 to perform one or more operations on computer usable information. Accordingly, computer programs represent controllers of the computer system 600.

Computer programs and computer usable information are typically stored in secondary memory 610 or obtained via communications interface 624. When needed by the processor(s) 604, the computer programs and/or computer usable information are typically, but not necessarily, copied into main memory 608, which serves as a local, fast-access memory for the processor(s) 604.

Herein, the terms “computer program product,” “computer program medium,” “computer usable medium,” “communications medium,” “storage device,” and “computer useable form,” are used interchangeably to generally refer to media such as main memory 608, secondary memory 610 (including removable storage units 618 and 622), communications interface 624, signals 628, and communications path 626, which are capable of storing and/or communicating computer programs and/or computer usable information.

In accordance with the present invention, a virtual representation of a protein is copied into a memory (e.g., main memory 608 and/or secondary memory 610) of the computer system 600. The virtual representation of a protein is assessed and modified as described above with respect to FIGS. 1 and 2. The assessment and/or modification can be performed in a fully automated fashion under control the one or more processors 604 and under control of one or more computer programs that are stored on a computer usable medium and that execute on the computer system 600. The assessment and/or modification can also be performed with user input and/or control as well.

### V. Conclusion

The present invention has been described above with the aid of functional building blocks illustrating the performance of specified functions and relationships thereof. The boundaries of these functional building blocks have been arbitrarily defined herein for the convenience of the description. Alternate boundaries can be defined so long as the specified functions and relationships thereof are appropriately performed. Any such alternate boundaries are thus within the scope and spirit of the claimed invention. One skilled in the art will recognize that these functional building blocks can be implemented by discrete components, application specific integrated circuits, processors executing appropriate software, and the like, and/or combinations thereof.

When used herein, the terms “connected” and/or “coupled” are generally used to refer to electrical connections. Such electrical connections can be direct electrical connections with no intervening components, and/or indirect electrical connections through one or more components.

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

What is claimed is:

1. A method for preparing a virtual representation of a protein for in-silico processing, comprising:
(1) assessing the virtual representation of the protein for missing residues;
(2) modifying the virtual representation of the protein when a missing residue is detected;
(3) assessing the virtual representation of the protein for missing side chains;
(4) modifying the virtual representation of the protein when a missing side chain is detected; and
(5) outputting the modified virtual representation of the protein.

2. The method according to claim 1, wherein step (1) comprises comparing a sequence listing of the protein with the virtual representation of the protein to determine whether any residues listed in the sequence listing are missing from the virtual representation of the protein.

3. The method according to claim 1, wherein step (1) comprises examining entries in a residue-number column of a protein database file for missing numbers.

4. The method according to claim 1, wherein step (1) comprises examining a header section of the virtual representation of the protein for an identification of residues missing from the virtual representation of the protein.

5. The method according to claim 1, wherein step (3) comprises comparing a portion of the virtual representation of the protein with a template.

6. The method according to claim 1, wherein step (4) comprises identifying multiple solutions for a missing side chain and modifying the virtual representation of the protein with a selected one of the multiple solutions.

7. The method according to claim 1, further comprising:
(1) assessing the virtual representation of the protein for atoms that are not part of the protein; and
(2) modifying the virtual representation of the protein when an atom that is not part of the protein is identified.

8. The method according to claim 7, wherein step (2) comprises removing an atom that is not part of the protein from the virtual representation of the protein.

9. The method according to claim 1, further comprising:
(1) assessing the virtual representation of the protein for hydrogen atom sites; and
(2) modifying the virtual representation of the protein to include a hydrogen atom when a hydrogen atom site is identified.

10. The method according to claim 9, wherein step (2) comprises assigning initial coordinates to the hydrogen atom.

11. The method according to claim 10, wherein step (2) further comprises determining an orientation of the hydrogen atom and modifying the initial coordinates to correspond to the orientation.

12. The method according to claim 11, wherein step (2) further comprises selecting the orientation of the hydrogen atom from a look-up table.

13. The method according to claim 11, wherein step (2) further comprises determining the orientation of the hydrogen atom present on the side chain of a residue using a search and evaluation process, wherein the conformation of the functional group associated with the hydrogen atom is sampled to determine a low energy conformation.

14. The method according to claim 13, wherein step (2) further comprises determining the orientation of the hydrogen atom using a simulated annealing process.

15. The method according to claim 14, wherein the simulated annealing process calculates the coordinates of the hydrogen atom that provide a relatively low energy state for the residue.

16. The method according to claim 14, wherein the simulated annealing process receives as input information relating to features that are relatively near to the hydrogen atom.

17. The method according to claim 9, further comprising assigning a protonation state to the residue.

18. The method according to claim 9, further comprising:
(1) determining if the partial charges or electron distribution of one or more regions of the protein must be recalculated; and
(2) optionally assigning and/or modifying the partial charges or electron distribution of one or more regions of the protein.

19. The method according to claim 1, further comprising:
(1) assessing an energy state of the virtual representation of the protein; and
(2) modifying the virtual representation of the protein to reduce the energy state.

20. The method according to claim 1, further comprising:
(1) assessing a structural quality of the virtual representation of the protein;
(2) assessing a structural quality of the modified virtual representation of the protein;
(3) comparing the structural quality assessments of steps (1) and (2); and
(4) replacing the virtual representation of the protein with the modified virtual representation of the protein when the structural quality of the modified virtual representation of the protein is better than the structural quality of the virtual representation of the protein.

21. The method according to claim 1, wherein at least a portion of one or more of steps (1) through (4) are performed in a computer system under control of a computer program.

22. The method according to claim 1, wherein at least a portion of one or more of steps (1) through (4) are performed in a computer system under control of a computer program based on input received from a user.

23. The method according to claim 1, further comprising minimizing an energy level of the virtual representation of the protein.

24. The method according to claim 1, further comprising minimizing the energy level of a portion of the virtual representation of the protein.

25. The method according to claim 1, further comprising minimizing the energy level of a binding site of the virtual representation of the protein.

26. The method according to claim 25, further comprising minimizing the energy level of the binding site including a virtual representation of a small molecule coupled to the binding site.

27. The method according to claim 26, further comprising minimizing the energy level of the binding site including a virtual representation of a peptide coupled to the binding site.

28. The method according to claim 1, further comprising mutating a residue of the virtual representation of the protein.

29. A system for preparing a virtual representation of a protein for in-silico processing, comprising:
a database for storing a virtual representation of the protein;
a virtual representation engine for accessing and modifying the virtual representation of the protein to produce a modified virtual presentation of the protein; and
an output module for outputting the modified virtual presentation of the protein;
wherein the virtual representation engine assesses the virtual representation of the protein for missing residues and modifies the virtual representation of the protein when a missing residue is detected; and
wherein the virtual representation engine assesses the virtual representation of the protein for missing side chains and modifies the virtual representation of the protein when a missing side chain is detected.

30. The system according to claim 29, wherein the virtual representation engine assessing the virtual representation of the protein for missing residues comprises comparing a sequence listing of the protein with the virtual representation of the protein to determine whether any residues listed in the sequence listing are missing from the virtual representation of the protein.

31. The system according to claim 29, wherein the virtual representation engine assessing the virtual representation of the protein for missing residues comprises examining entries in a residue-number column of a protein database file for missing numbers.

32. The system according to claim 29, wherein the virtual representation engine assessing the virtual representation of the protein for missing residues comprises examining a header section of the virtual representation of the protein for an identification of residues missing from the virtual representation of the protein.

33. The system according to claim 29, wherein the virtual representation engine assessing the virtual representation of the protein for missing side chains comprises comparing a portion of the virtual representation of the protein with a template.

34. The system according to claim 29, wherein the virtual representation engine modifying the virtual representation of the protein when a missing side chain is detected comprises identifying multiple solutions for a missing side chain and modifying the virtual representation of the protein with a selected one of the multiple solutions.

35. The system according to claim 29, further comprising the virtual representation engine assesses the virtual representation of the protein for atoms that are not part of the protein and modifies the virtual representation of the protein when an atom that is not part of the protein is identified.

36. The system according to claim 35, wherein the virtual representation engine modifying the virtual representation of the protein when an atom that is not part of the protein is identified comprises removing an atom that is not part of the protein from the virtual representation of the protein.

37. The system according to claim 29, further comprising the virtual representation engine assesses the virtual representation of the protein for hydrogen atom sites and modifies the virtual representation of the protein to include a hydrogen atom when a hydrogen atom site is identified.

38. The system according to claim 37, wherein the virtual representation engine modifying the virtual representation of the protein to include a hydrogen atom when a hydrogen atom site is identified comprises assigning initial coordinates to the hydrogen atom.

39. The system according to claim 38, wherein the virtual representation engine modifying the virtual representation of the protein to include a hydrogen atom when a hydrogen atom site is identified further comprises determining an orientation of the hydrogen atom and modifying the initial coordinates to correspond to the orientation.

40. The system according to claim 39, wherein the virtual representation engine modifying the virtual representation of the protein to include a hydrogen atom when a hydrogen atom site is identified further comprises selecting the orientation of the hydrogen atom from a look-up table.

41. The system according to claim 39, wherein the virtual representation engine modifying the virtual representation of the protein to include a hydrogen atom when a hydrogen atom site is identified further comprises determining the orientation of the hydrogen atom using a search and evaluation process.

42. The system according to claim 41, wherein the virtual representation engine modifying the virtual representation of the protein to include a hydrogen atom when a hydrogen atom site is identified further comprises determining the orientation of the hydrogen atom using a simulated annealing process.

43. The system according to claim 42, wherein the simulated annealing process calculates the coordinates of the hydrogen atom that provide a relatively low energy state for the residue.

44. The system according to claim 42, wherein the simulated annealing process receives input information relating to features that are relatively near to the hydrogen atom.

45. The system according to claim 37, wherein the virtual representation engine assigns a protonation state to the residue.

46. The system according to claim 29, wherein the virtual representation engine assesses an energy state of the virtual representation of the protein and modifies the virtual representation of the protein to reduce the energy state.

47. The system according to claim 29, further comprising:
wherein the virtual representation engine assesses a structural quality of the virtual representation of the protein and accesses a structural quality of the modified virtual representation of the protein,
wherein the virtual representation engine further compares the structural quality assessments of the virtual representation of the protein and of the modified virtual representation of the protein, and
wherein the virtual representation engine replaces the virtual representation of the protein with the modified virtual representation of the protein when the structural quality of the modified virtual representation of the protein is better than the structural quality of the virtual representation of the protein.

48. The system according to claim 29, wherein at least a portion of one or more of the virtual representation engine assessing the virtual representation of the protein for missing residues, the virtual representation engine modifying the virtual representation of the protein when a missing residue is detected, the virtual representation engine assessing the virtual representation of the protein for missing side chains and the virtual representation engine modifying the virtual representation of the protein when a missing side chain is detected are performed in a computer system under control of a computer program.

49. The system according to claim 29, wherein at least a portion of the virtual representation engine assessing the virtual representation of the protein for missing residues, the virtual representation engine modifying the virtual representation of the protein when a missing residue is detected, the virtual representation engine assessing the virtual representation of the protein for missing side chains and the virtual representation engine modifying the virtual representation of the protein when a missing side chain is detected are performed in a computer system under control of a computer program based on input received from a user.

50. The system according to claim 29, further comprising the virtual representation engine minimizing an energy level of the virtual representation of the protein.

51. The system according to claim 50, further comprising the virtual representation engine minimizing the energy level of a portion of the virtual representation of the protein.

52. The system according to claim 51, further comprising the virtual representation engine minimizing the energy level of a binding site of the virtual representation of the protein.

53. The system according to claim 52, further comprising the virtual representation engine minimizing the energy level of the binding site including a virtual representation of a small molecule coupled to the binding site.

54. The system according to claim 53, further comprising the virtual representation engine minimizing the energy level of the binding site including a virtual representation of a peptide coupled to the binding site.

55. The system according to claim 29, further comprises the virtual representation engine mutates a residue of the virtual representation of the protein.

56. A computer program product including a computer useable medium having computer program logic stored therein to enable a computer system to prepare a virtual representation of a protein for in-silico processing, wherein said computer program logic comprises:
a first function that causes the computer system to assess the virtual representation of the protein for missing residues;
a second function that causes the computer system to modify the virtual representation of the protein when a missing residue is detected;
a third function that causes the computer system to assess the virtual representation of the protein for missing side chains; and
a fourth function that causes the computer system to modify the virtual representation of the protein when a missing side chains is detected.

57. The computer program product according to claim 56, wherein the first function that causes the computer system to assess comprises comparing a sequence listing of the protein with the virtual representation of the protein to determine whether any residues listed in the sequence listing are missing from the virtual representation of the protein.

58. The computer program product according to claim 56, wherein the first function that causes the computer system to assess comprises examining entries in a residue-number column of a protein database file for missing numbers.

59. The computer program product according to claim 56, wherein the first function that causes the computer system to assess comprises examining a header section of the virtual representation of the protein for an identification of residues missing from the virtual representation of the protein.

60. The computer program product according to claim 56, wherein the third function that causes the computer system to assess comprises comparing a portion of the virtual representation of the protein with a template.

61. The computer program product according to claim 56, wherein the fourth function that causes the computer system to modify comprises identifying multiple solutions for a missing side chain and modifying the virtual representation of the protein with a selected one of the multiple solutions.

62. The computer program product according to claim 56, wherein the computer program logic further comprises:
a fifth function that causes the computer system to assess the virtual representation of the protein for atoms that are not part of the protein; and
a sixth function that causes the computer system to modify the virtual representation of the protein when an atom that is not part of the protein is identified

63. The computer program product according to claim 62, wherein the sixth function that causes the computer system to modify comprises removing an atom that is not part of the protein from the virtual representation of the protein.

64. The computer program product according to claim 56, wherein the computer program logic further comprises:
a fifth function that causes the computer system to assess the virtual representation of the protein for hydrogen atom sites; and
a sixth function that causes the computer system to modify the virtual representation of the protein to include a hydrogen atom when a hydrogen atom site is identified.

65. The computer program product according to claim 62, wherein the sixth function that causes the computer system to modify comprises assigning initial coordinates to the hydrogen atom.

66. The computer program product according to claim 65, wherein the sixth function that causes the computer system to modify further comprises determining an orientation of the hydrogen atom and modifying the initial coordinates to correspond to the orientation.

67. The computer program product according to claim 66, wherein the sixth function that causes the computer system to modify further comprises selecting the orientation of the hydrogen atom from a look-up table.

68. The computer program product according to claim 66, wherein the sixth function that causes the computer system to modify further comprises determining the orientation of the hydrogen atom using a search and evaluation process.

69. The computer program product according to claim 68, wherein the sixth function that causes the computer system to modify further comprises determining the orientation of the hydrogen atom using a simulated annealing process.

70. The computer program product according to claim 69, wherein the simulated annealing process calculates the coordinates of the hydrogen atom that provide a relatively low energy state for the residue.

71. The computer program product according to claim 69, wherein the simulated annealing process receives as input information relating to features that are relatively near to the hydrogen atom.

72. The computer program product according to claim 64, wherein the computer program logic further comprises:
a seventh function that causes the computer system to assign a protonation state to the residue.

73. The computer program product according to claim 56, wherein the computer program logic further comprises:
a fifth function that causes the computer system to assess an energy state of the virtual representation of the protein; and
a sixth function that causes the computer system to modify the virtual representation of the protein to reduce the energy state.

74. The computer program product according to claim 56, wherein the computer program logic further comprises:
a fifth function that causes the computer system to assess a structural quality of the virtual representation of the protein;
a sixth function that causes the computer system to assess a structural quality of the modified virtual representation of the protein;
a seventh function that causes the computer system to compare the structural quality assessments of the fifth function and the sixth function; and
an eighth function that causes the computer system to replace the virtual representation of the protein with the modified virtual representation of the protein when the structural quality of the modified virtual representation of the protein is better than the structural quality of the virtual representation of the protein.

75. The computer program product according to claim 56, wherein at least a portion of one or more of functions one through four are performed in a computer system under control of a computer program.

76. The computer program product according to claim 56, wherein at least a portion of one or more of functions one through four are performed in a computer system under control of a computer program based on input received from a user.

77. The computer program product according to claim 56, further comprising a fifth function that causes a computer system to minimize an energy level of the virtual representation of the protein.

78. The computer program product according to claim 77, further comprising a sixth function that causes a computer system to minimize the energy level of a portion of the virtual representation of the protein.

79. The computer program product according to claim 78, further comprising a seventh function that causes a computer system to minimize the energy level of a binding site of the virtual representation of the protein.

80. The computer program product according to claim 79, further comprising an eighth function that causes a computer system to minimize the energy level of the binding site of including a virtual representation of a small molecule coupled to the binding site.

81. The computer program product according to claim 80, further comprising a ninth function that causes a computer system to minimize the energy level of the binding site including a virtual representation of a peptide coupled to the binding site.

82. The computer program product according to claim 56, further comprising a fifth function that causes a computer system to mutate a residue of the virtual representation of the protein.

83. The computer program product according to claim 56, further comprising a fifth function that causes a computer system to output the modified virtual representation of the protein.

84. An apparatus for preparing a virtual representation of a protein for in-silico processing, comprising:
means for assessing the virtual representation of the protein for missing residues;
means for modifying the virtual representation of the protein when a missing residue is detected;
means for assessing the virtual representation of the protein for missing side chains; and
means for modifying the virtual representation of the protein when a missing side chains is detected.

85. The apparatus according to claim 84, wherein the means for assessing the virtual representation of the protein for missing residues comprises means for comparing a sequence listing of the protein with the virtual representation of the protein to determine whether any residues listed in the sequence listing are missing from the virtual representation of the protein.

86. The apparatus according to claim 84, wherein the means for assessing the virtual representation of the protein for missing residues comprises means for examining entries in a residue-number column of a protein database file for missing numbers.

87. The apparatus according to claim 84, wherein the means for assessing the virtual representation of the protein for missing residues comprises means for examining a header section of the virtual representation of the protein for an identification of residues missing from the virtual representation of the protein.

88. The apparatus according to claim 84, wherein the means for assessing the virtual representation of the protein for missing side chains comprises means for comparing a portion of the virtual representation of the protein with a template.

89. The apparatus according to claim 84, wherein the means for modifying the virtual representation of the protein when a missing side chains is detected comprises:
means for identifying multiple solutions for a missing side chain; and
means for modifying the virtual representation of the protein with a selected one of the multiple solutions.

90. The apparatus according to claim 84, further comprising:
means for assessing the virtual representation of the protein for atoms that are not part of the protein; and
means for modifying the virtual representation of the protein when an atom that is not part of the protein is identified

91. The apparatus according to claim 90, wherein the means for modifying the virtual representation of the protein when an atom that is not part of the protein is identified comprises means for removing an atom that is not part of the protein from the virtual representation of the protein.

92. The apparatus according to claim 84, further comprising:
means for assessing the virtual representation of the protein for hydrogen atom sites; and
means for modifying the virtual representation of the protein to include a hydrogen atom when a hydrogen atom site is identified.

93. The apparatus according to claim 92, wherein the means for modifying the virtual representation of the protein to include a hydrogen atom when a hydrogen atom site is identified comprises means for assigning initial coordinates to the hydrogen atom.

94. The apparatus according to claim 93, wherein the means for modifying the virtual representation of the protein to include a hydrogen atom when a hydrogen atom site is identified further comprises:
means for determining an orientation of the hydrogen atom; and
means for modifying the initial coordinates to correspond to the orientation.

95. The apparatus according to claim 94, wherein the means for modifying the virtual representation of the protein to include a hydrogen atom when a hydrogen atom site is identified further comprises means for selecting the orientation of the hydrogen atom from a look-up table.

96. The apparatus according to claim 94, wherein the means for modifying the virtual representation of the protein to include a hydrogen atom when a hydrogen atom site is identified further comprises means for determining the orientation of the hydrogen atom using a search and evaluation process.

97. The apparatus according to claim 96, wherein the means for modifying the virtual representation of the protein to include a hydrogen atom when a hydrogen atom site is identified further comprises means for determining the orientation of the hydrogen atom using a simulated annealing process.

98. The apparatus according to claim 97, wherein the simulated annealing process calculates the coordinates of the hydrogen atom that provide a relatively low energy state for the residue.

99. The apparatus according to claim 97, wherein the simulated annealing process receives as input information relating to features that are relatively near to the hydrogen atom.

100. The apparatus according to claim 92, further comprising means for assigning a protonation state to a residue.

101. The apparatus according to claim 84, further comprising:
means for assessing an energy state of the virtual representation of the protein; and
means for modifying the virtual representation of the protein to reduce the energy state.

102. The apparatus according to claim 84, further comprising:
means for assessing a structural quality of the virtual representation of the protein;
means for assessing a structural quality of the modified virtual representation of the protein;
means for comparing the structural quality assessments of the means for assessing a structural quality of the virtual representation of the protein and the means for assessing a structural quality of the modified virtual representation of the protein; and
means for replacing the virtual representation of the protein with the modified virtual representation of the protein when the structural quality of the modified virtual representation of the protein is better than the structural quality of the virtual representation of the protein.

103. The apparatus according to claim 84, wherein at least a portion of one or more of the means for assessing the virtual representation of the protein for missing residues, the means for modifying the virtual representation of the protein when a missing residue is detected, the means for assessing the virtual representation of the protein for missing side chains, and the means for modifying the virtual representation of the protein when a missing side chains is detected are performed in a computer system under control of a computer program.

104. The apparatus according to claim 84, wherein at least a portion of one or more of the means for assessing the virtual representation of the protein for missing residues, the means for modifying the virtual representation of the protein when a missing residue is detected, the means for assessing the virtual representation of the protein for missing side chains, and the means for modifying the virtual representation of the protein when a missing side chains is detected are performed in a computer system under control of a computer program based on input received from a user.

105. The apparatus according to claim 84, further comprising means for minimizing an energy level of the virtual representation of the protein.

106. The apparatus according to claim 105, further comprising means for minimizing the energy level of a portion of the virtual representation of the protein.

107. The apparatus according to claim 106, further comprising means for minimizing the energy level of a binding site of the virtual representation of the protein.

108. The apparatus according to claim 107, further comprising means for minimizing the energy level of the binding site of including a virtual representation of a small molecule coupled to the binding site.

109. The apparatus according to claim 108, further comprising means for minimizing the energy level of the binding site including a virtual representation of a peptide coupled to the binding site.

110. The apparatus according to claim 84, further comprising means for mutating a residue of the virtual representation of the protein.

111. The apparatus according to claim 84, further comprising means for outputting the modified virtual representation of the protein.

112. A method for preparing a virtual representation of a protein for in-silico processing, comprising the steps of:
(1) assessing the virtual representation of the protein for missing residues;
(2) modifying the virtual representation of the protein when a missing residue is detected;
(3) assessing the virtual representation of the protein for missing side chains;
(4) modifying the virtual representation of the protein when a missing side chain is detected;
(5) assessing the virtual representation of the protein for atoms that are not part of the protein;
(6) modifying the virtual representation of the protein when an atom that is not part of the protein is identified
(7) assessing the virtual representation of the protein for hydrogen atom sites;
(8) modifying the virtual representation of the protein to include hydrogen atoms at the hydrogen atom sites;
(9) assigning initial coordinates to the hydrogen atoms; and
(10) modifying the virtual representation of the protein to include protonation states for the residue.

113. A system for preparing a virtual representation of a protein for in-silico processing, comprising:
a database for storing a virtual representation of the protein;
a virtual representation engine for accessing and modifying the virtual representation of the protein to produce a modified virtual presentation of the protein; and
an output module for displaying the modified virtual presentation of the protein;
wherein the virtual representation engine assesses the virtual representation of the protein for missing residues and modifies the virtual representation of the protein when a missing residue is detected;
wherein the virtual representation engine assesses the virtual representation of the protein for missing side chains and modifies the virtual representation of the protein when a missing side chain is detected;
wherein the virtual representation engine assesses the virtual representation of the protein for atoms that are not part of the protein and modifies the virtual representation of the protein when an atom that is not part of the protein is identified;
wherein the virtual representation engine assesses the virtual representation of the protein for hydrogen atom sites and modifies the virtual representation of the protein to include hydrogen atoms at the hydrogen atom sites; and
wherein the virtual representation engine assigns initial coordinates to the hydrogen atoms and modifies the virtual representation of the protein to include protonation states for the residue.

114. A computer program product including a computer useable medium having computer program logic stored therein to enable a computer system to prepare a virtual representation of a protein for in-silico processing, where the computer program logic comprises:
a first function that causes the computer system to assess the virtual representation of the protein for missing residues;
a second function that causes the computer system to modify the virtual representation of the protein when a missing residue is detected;
a third function that causes the computer system to assess the virtual representation of the protein for missing side chains;
a fourth function that causes the computer system to modify the virtual representation of the protein when a missing side chain is detected;
a fifth function that causes the computer system to assess the virtual representation of the protein for atoms that are not part of the protein;
a sixth function that causes the computer system to modify the virtual representation of the protein when an atom that is not part of the protein is identified
a seventh function that causes the computer system to assess the virtual representation of the protein for hydrogen atom sites;
an eighth function that causes the computer system to modify the virtual representation of the protein to include hydrogen atoms at the hydrogen atom sites;
a ninth function that causes the computer system to assign initial coordinates to the hydrogen atoms; and
a tenth function that causes the computer system to modify the virtual representation of the protein to include protonation states for the residue.

115. An apparatus for preparing a virtual representation of a protein for in-silico processing, comprising:
means for assessing the virtual representation of the protein for missing residues;
means for modifying the virtual representation of the protein when a missing residue is detected;
means for assessing the virtual representation of the protein for missing side chains;
means for modifying the virtual representation of the protein when a missing side chain is detected;
means for assessing the virtual representation of the protein for atoms that are not part of the protein;
means for modifying the virtual representation of the protein when an atom that is not part of the protein is identified
means for assessing the virtual representation of the protein for hydrogen atom sites;
means for modifying the virtual representation of the protein to include hydrogen atoms at the hydrogen atom sites;
means for assigning initial coordinates to the hydrogen atoms; and
means for modifying the virtual representation of the protein to include protonation states for the residue.
